(19) United States
(12) Patent Application Publication
(10) Pub. No.: US 2020/0097058 A1
(43) Pub. Date: Mar. 26, 2020

(54) COMPUTING DEVICES, POWER SUPPLY DEVICES, METHODS FOR CONTROLLING A COMPUTING DEVICE, AND METHODS FOR CONTROLLING A POWER SUPPLY DEVICE

(71) Applicant: RAZER (ASIA-PACIFIC) PTE. LTD., Singapore (SG)

(72) Inventor: Jian Yao LIEN, Singapore (SG)

(21) Appl. No.: 16/083,387

(22) PCT Filed: Mar. 9, 2016
(86) PCT No.: PCT/SG2016/050110

§ 371 Date: Sep. 7, 2018

(51) Int. Cl. G06F 1/26; G06F 1/24; H02J 7/00

(52) U.S. Cl. CPC G06F 1/263; G06F 1/24; H02J 7/0052; H02J 7/0045; H02J 7/0034

(57) ABSTRACT

According to various embodiments, a computing device may be provided. The computing device may include: a battery; a power supply connector; a connection determination circuit configured to determine an input connected to the power supply connector; a charging circuit configured to charge the battery if the connection determination circuit determines a first input connected to the power supply connector; and an exception circuit configured to instruct the computing device to perform exception processing if the connection determination circuit determines a second input connected to the power supply connector.

### TECHNICAL FIELD

Various embodiments generally relate to computing devices, power supply devices, methods for controlling a computing device, and methods for controlling a power supply device.

### BACKGROUND

A forced shutdown function or a force reset function is very commonly found on smart electronic devices that are running complex algorithms. However, in commonly used devices, complex user interaction may be required to trigger such a forced shutdown function or forced reset function. Thus, there may be a need for improved devices.

### SUMMARY OF THE INVENTION

According to various embodiments, a computing device may be provided. The computing device may include: a battery; a power supply connector; a connection determination circuit configured to determine an input connected to the power supply connector; a charging circuit configured to charge the battery if the connection determination circuit determines a first input connected to the power supply connector; and an exception circuit configured to instruct the computing device to perform exception processing if the connection determination circuit determines a second input connected to the power supply connector.

According to various embodiments, a power supply device may be provided. The power supply device may include: a power output connector; and a switch configured to switch between a first state in which the power output connector outputs an output for charging a computing device and a second state in which the power output connector outputs an output for initiating exception processing in the computing device.

According to various embodiments, a method for controlling a computing device may be provided. The method may include: determining an input connected to a power supply connector of the computing device; charging a battery if a first input connected to the power supply connector is determined; and performing exception processing if a second input connected to the power supply connector is determined.

According to various embodiments, a method for controlling a power supply device may be provided. The method may include switching, using a switch, between a first state in which a power output connector of the power supply device outputs an output for charging a computing device and a second state in which the power output connector outputs an output for initiating exception processing in the computing device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1A shows a computing device according to various embodiments;

FIG. 1B shows a computing device according to various embodiments;

FIG. 1C shows a power supply device according to various embodiments;

FIG. 1D shows a flow diagram illustrating a method for controlling a computing device;

FIG. 1E shows a flow diagram illustrating a method for controlling a power supply device;

FIG. 2 shows an illustration of a system with a device and a charging connector according to various embodiments; and

FIG. 3 shows a device according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the computing device as described in this description may include a memory which is for example used in the processing carried out in the computing device. In this context, the power supply device as described in this description may include a memory which is for example used in the processing carried out in the power supply device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

A forced shutdown function or a force reset function is very commonly found on smart electronic devices that are running complex algorithms. However, in commonly used devices, complex user interaction may be required to trigger such a forced shutdown function or forced reset function. According to various embodiments, improved devices may be provided. According to various embodiments, forced shutdown/reset functions may be provided on a wearable (in other words: on a wearable device).

According to various embodiments, a reverse voltage forced shutdown/reset function on a two contact (for example two pin) charging port for wearables may be provided.

Various embodiments may provide a forced shutdown/reset function on wearables, such as the Nabu X, for example by running a reverse voltage through charging contacts (for example charging pins) which are normally used for recharging, without any user input interface (e.g. without any push button). Such embodiments may be suited for button-less wearables (in other words: wearables that have no buttons and switches) that require frequent firmware (FW) updates which a failed update may put the device into a hang state. This may improve user experience as such a function (or circuit) may empower the user to perform a forced shutdown/reset (for example directly) on the device.

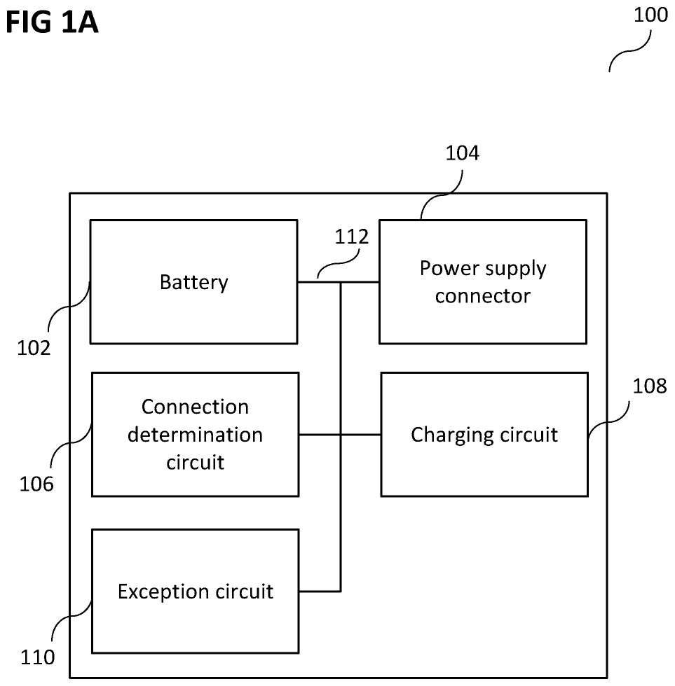

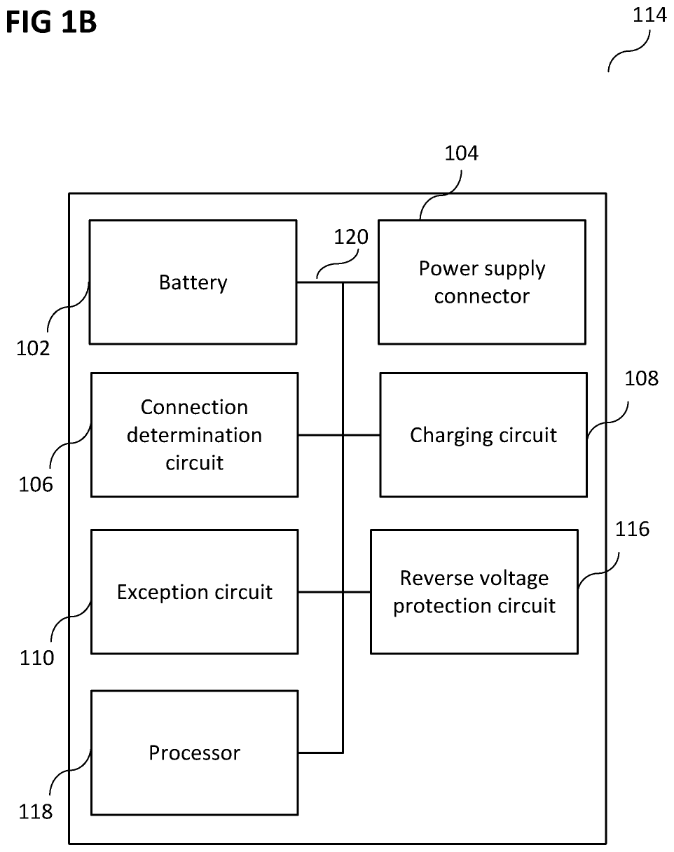

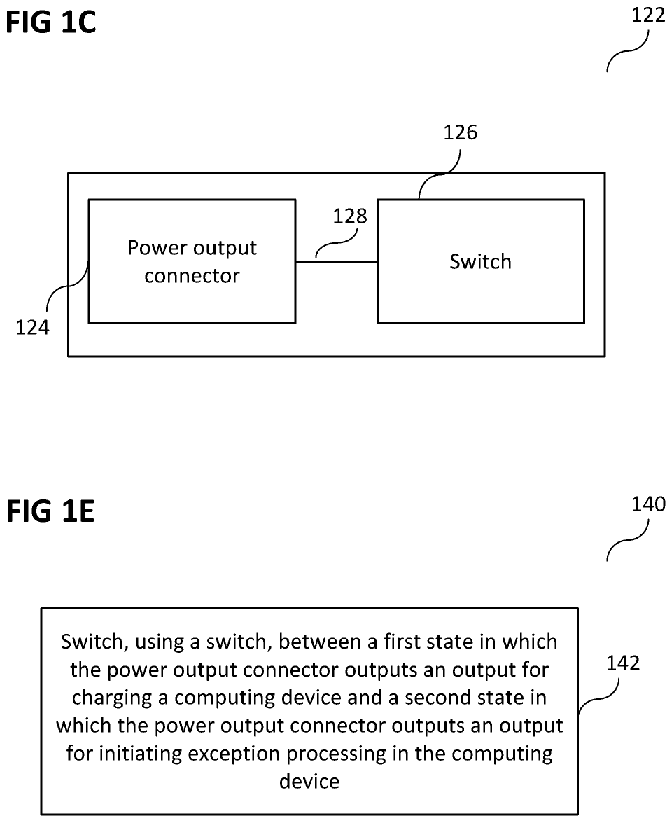

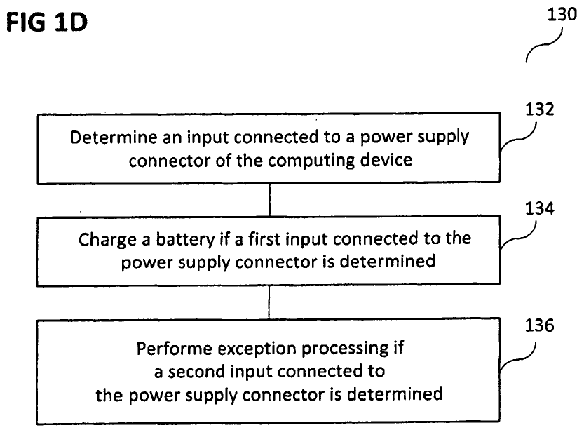

FIG. 1A shows a computing device 100 (for example a wearable, in other words: a wearable device) according to various embodiments. The computing device 100 may include a battery 102. The computing device 100 may further include a power supply connector 104 (which for example may be configured to receive power supply from an external source, for example from a power supply device like illustrated in FIG. 1C). The computing device 100 may further include a connection determination circuit 106 configured to determine an input connected to the power supply connector 104. The computing device 100 may further include a charging circuit 108 configured to charge the battery 102 if the connection determination circuit 106 determines a first input connected to the power supply connector 104. The computing device 100 may further include an exception circuit 110 configured to instruct the computing device 100 to perform exception processing if the connection determination circuit 106 determines a second input connected to the power supply connector 104. The battery 102, the power supply connector 104, the connection determination circuit 106, the charging circuit 108, and the exception circuit 110 may be coupled with each other, like indicated by lines 112, for example electrically coupled, for example using a line or a cable, and/or mechanically coupled.

In other words, the computing device 100 may perform charging or an exception processing, based on the input provided to the power supply connector 104.

According to various embodiments, the connection determination circuit 106 may include or may be a voltage polarity determination circuit (not shown in FIG. 1A) configured to determine a polarity of a power supply connected to the power supply connector 104. According to various embodiments, the first input may include or may be a power supply of a first polarity. According to various embodiments, the second input may include or may be a power supply of a second polarity. In other words, the charging circuit 108 may be configured to charge the battery 102 if the voltage polarity determination circuit determines a first polarity of the power supply, and the exception circuit 110 may be configured to instruct the computing device 100 to perform exception processing if the voltage polarity determination circuit determines a second polarity of the power supply.

According to various embodiments, the first polarity may be inverted compared to the second polarity (in other words: may be opposing to the second polarity).

According to various embodiments, the first polarity of the power supply may include or may be a plus pole of the power supply provided to the first contact and a negative pole of the power supply provided to the second contact.

According to various embodiments, the second polarity of the power supply may include or may be a negative pole of the power supply provided to the first contact and a plus pole of the power supply provided to the second contact.

FIG. 1B shows a computing device 114 (for example a wearable, in other words: a wearable device) according to various embodiments. The computing device 114 may, similar to the computing device 100 of FIG. 1A, include a battery 102. The computing device 114 may, similar to the computing device 100 of FIG. 1A, further include a power supply connector 104. The computing device 114 may, similar to the computing device 100 of FIG. 1A, further include a connection determination circuit 106 configured to determine a polarity of the power supply. The computing device 114 may, similar to the computing device 100 of FIG. 1A, further include a charging circuit 108 configured to charge the battery 102 if the connection determination circuit 106 determines a first polarity of the power supply. The computing device 114 may, similar to the computing device 100 of FIG. 1A, further include an exception circuit 110 configured to instruct the computing device 114 to perform exception processing if the connection determination circuit 106 determines a second polarity of the power supply. The computing device 114 may further include a reverse voltage protection circuit 116, like will be described in more detail below. The computing device 114 may further include a processor 118, like will be described in more detail below. The battery 102, the power supply connector 104, the connection determination circuit 106, the charging circuit 108, the exception circuit 110, the reverse voltage protection circuit 116, and the processor 118 may be coupled with each other, like indicated by lines 120, for example electrically coupled, for example using a line or a cable, and/or mechanically coupled.

According to various embodiments, the reverse voltage protection circuit 116 may be configured to protect the computing device 114 from damage due to a voltage of the second polarity.

According to various embodiments, the connection determination circuit 106 may include or may be a short circuit determination circuit (not shown in FIG. 1B) configured to determine whether a short circuit is provided at the power supply connector 104. According to various embodiments, the first input may include or may be an input different from a short circuit. According to various embodiments, the second input may include or may be a short circuit. In other words, the charging circuit 108 may be configured to charge the battery'102 if the short circuit determination circuit determines that a voltage different from a short circuit is provided at the power supply connector 104, and the exception circuit 110 may be configured to instruct the computing device 100 or the computing device 114 to perform exception processing if the short circuit determination circuit determines that a short circuit is provided at the power supply connector 104.

According to various embodiments, the exception processing may include or may be or may be included in shutting down the computing device 100 or the computing device 114.

According to various embodiments, the exception processing may include or may be or may be included in restarting the computing device.

According to various embodiments, the power supply connector 104 may include or may be or may be included in a plurality of contacts.

According to various embodiments, the power supply connector 104 may include or may be or may be included in a first contact and a second contact.

According to various embodiments, the exception circuit 110 may include a delay circuit configured to delay the exception processing by a pre-determined amount of time.

According to various embodiments, the exception processing may include or may be or may be included in a reset of the processor 118.

FIG. 1C shows a power supply device 122 according to various embodiments. The power supply device 122 may include a power output connector 124. The power supply device 122 may further include a switch 126 (for example a mechanical switch or for example an electronic switch) configured to switch between a first state in which the power output connector 124 outputs an output for charging a computing device and a second state in which the power output connector 124 outputs an output for initiating exception processing in the computing device. The power output connector 124 and the switch 126 may be coupled with each other, like indicated by line 128, for example electrically coupled, for example using a line or a cable, and/or mechanically coupled.

According to various embodiments, the power output connector 124 may be configured to output a voltage of a first polarity in the first state and to output a voltage of a second polarity in the second state.

According to various embodiments, the power output connector 124 may include or may be or may be included in a first contact and a second contact.

According to various embodiments, the voltage of the first polarity may include or may be a plus pole at the first contact and a negative pole at the second contact.

According to various embodiments, the voltage of the second polarity may include or may be a negative pole at the first contact and a negative pole at the second contact.

According to various embodiments, the power output connector 124 may be configured to output a predetermined voltage in the first state and to output a short circuit in the second state.

FIG. 1D shows a flow diagram 130 illustrating a method for controlling a computing device. In 132, an input connected to a power supply connector of the computing device may be determined. In 134, a battery of the computing device may be charged if a first input connected to the power supply connector is determined. In 136, exception processing may be performed if a second input connected to the power supply connector is determined.

According to various embodiments, determining the input may include or may be determining a polarity of a power supply connected to the power supply connector. According to various embodiments, the first input may include or may be a power supply of a first polarity. According to various embodiments, the second input may include or may be a power supply of a second polarity.

According to various embodiments, the first polarity may be inverted compared to the second polarity.

According to various embodiments, the method may further include protecting the computing device from damage due to a voltage of the second polarity.

According to various embodiments, determining the input may include or may be determining whether a short circuit is provided at the power supply connector. According to various embodiments, the first input may include or may be an input different from a short circuit. According to various embodiments, the second input may include or may be a short circuit.

According to various embodiments, the exception processing may include or may be or may be included in shutting down the computing device.

According to various embodiments, the exception processing may include or may be or may be included in restarting the computing device.

According to various embodiments, the power supply connector may include or may be or may be included in a plurality of contacts.

According to various embodiments, the power supply connector may include or may be or may be included in a first contact and a second contact.

According to various embodiments, the first polarity of the power supply may include or may be a plus pole of the power supply provided to the first contact and a negative pole of the power supply provided to the second contact.

According to various embodiments, the second polarity of the power supply may include or may be a negative pole of the power supply provided to the first contact and a plus pole of the power supply provided to the second contact.

According to various embodiments, the exception processing may be carried out after a delay of a pre-determined amount of time.

According to various embodiments, the exception processing may include or may be or may be included in a reset of a processor of the computing device.

FIG. 1E shows a flow diagram 140 illustrating a method for controlling a power supply device. In 142, it may be switched, for example using a switch on the power supply device, between a first state in which a power output connector of the power supply device outputs an output for charging a computing device and a second state in which the power output connector outputs an output for initiating exception processing in the computing device.

According to various embodiments, the power output connector may output a voltage of a first polarity in the first state and may output a voltage of a second polarity in the second state

According to various embodiments, the power output connector may include or may be or may be included in a first contact and a second contact.

According to various embodiments, the voltage of the first polarity may include or may be a plus pole at the first contact and a negative pole at the second contact.

According to various embodiments, the voltage of the second polarity may include or may be a negative pole at the first contact and a negative pole at the second contact.

According to various embodiments, the power output connector may output a predetermined voltage in the first state and may output a short circuit in the second state.

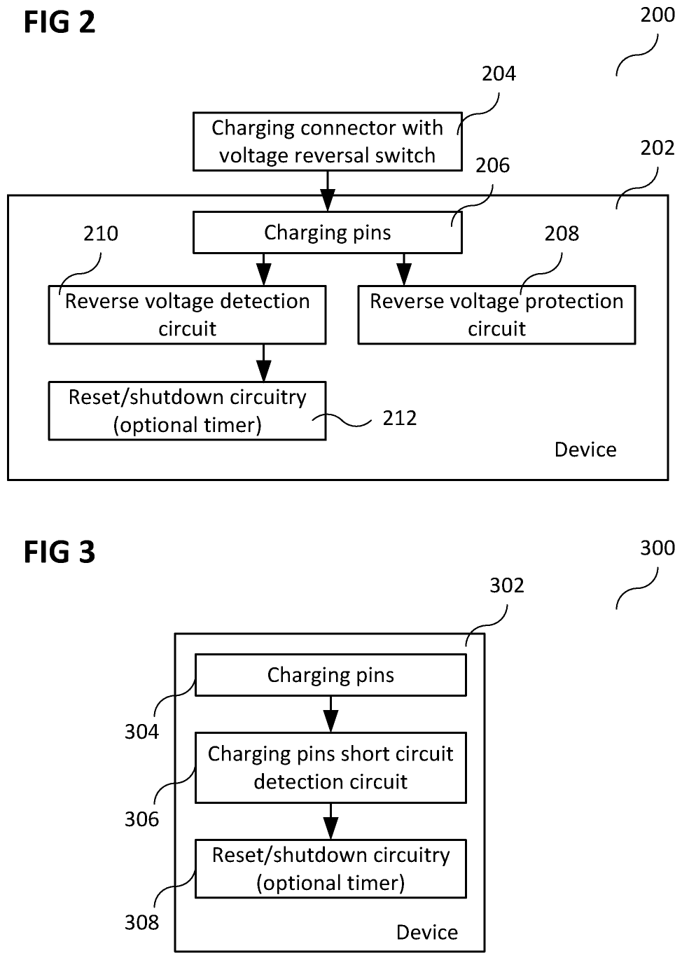

FIG. 2 shows an illustration 200 of a system with a device 202 (for example a computing device like illustrated in FIG. 1A or like illustrated in FIG. 1B) and a charging connector 204 (for example a power supply device like illustrated in FIG. 1C) according to various embodiments.

According to various embodiments, a circuitry may be provided to allow the same contact pins that are used for charging to perform (or to trigger or to initiate or to instruct or to start) a forced shutdown or reset on a main circuit board of the device 202. A reverse voltage may be applied to charging pins 206 of the device to achieve a forced shutdown on the main circuit board. The circuitry (for example reverse voltage detection circuit 210 and reset/shutdown circuit 212) may be further paired with a delay timer reset IC (integrated circuit) to achieve delayed timing reset. A charging cable with a built in voltage reversal switch may provide the reverse voltage to trigger the forced shutdown/reset function. The device 202 may further include a reverse voltage protection circuit 208.

According to various embodiments, a wearable device may be connected to a charging cable (for example live charging cable) with a built-in voltage reversal momentary switch in order to perform a forced shutdown/reset action.

According to various embodiments, a voltage reversal switch may be provided (for example on the charging cable), and when the voltage reversal switch is depressed, the following actions may be performed:

1. The “reverse voltage” protection circuit may kick in to protect the main circuitry from reversed voltage damage.

2. The “reverse voltage” detection circuit may activate the reset/shutdown circuitry.

3. The device may then go into reset/shutdown immediately or in the case of the usage of a reset/shutdown timer, go into reset/shutdown after time out.

According to various embodiments, a short pins forced shutdown/reset function on a two-pin charging port for wearables (in other words: wearable devices) may be provided.

According to various embodiments, circuitry may be provided to allow the same contact pins that are used for charging to perform a forced shutdown or reset on the main circuit board of the wearable device. This may be achieved by shorting the charging pins. The circuitry may be further paired with a delay timer reset IC to provide delayed timing RESET.

To perform a reset, the charging pins may be shorted with a conductive material (e.g. a pair of stainless steel tweezers) or a specially built charging cable with a momentarily push switch that disconnects the device's charging pins from the charging power source and then shorts the charging pins. The device may then go into reset/shutdown immediately or in the case of the usage of a reset/shutdown timer, go into reset/shutdown after time out.

FIG. 3 shows an illustration 300 of a device 302 according to various embodiments. The device 302 may include charging pins 304, a charging pins short circuit detection circuit 306, and a reset/shutdown circuitry 308 (which may include a timer).

The following examples pertain to further embodiments.

Example 1 is a computing device comprising: a battery; a power supply connector; a connection determination circuit configured to determine an input connected to the power supply connector; a charging circuit configured to charge the battery if the connection determination circuit determines a first input connected to the power supply connector; and an exception circuit configured to instruct the computing device to perform exception processing if the connection determination circuit determines a second input connected to the power supply connector.

In example 2, the subject-matter of example 1 can optionally include that the connection determination circuit comprises a voltage polarity determination circuit configured to determine a polarity of a power supply connected to the power supply connector; wherein the first input comprises a power supply of a first polarity; and wherein the second input comprises a power supply of a second polarity.

In example 3, the subject-matter of example 2 can optionally include that the first polarity is inverted compared to the second polarity.

In example 4, the subject-matter of any one of examples 2 to 3 can optionally include that the first polarity of the power supply comprises a plus pole of the power supply provided to the first contact and a negative pole of the power supply provided to the second contact.

In example 5, the subject-matter of any one of examples 2 to 4 can optionally include that the second polarity of the power supply comprises a negative pole of the power supply provided to the first contact and a plus pole of the power supply provided to the second contact.

In example 6, the subject-matter of any one of examples 2 to 5 can optionally include a reverse voltage protection circuit configured to protect the computing device from damage due to a voltage of the second polarity.

In example 7, the subject-matter of any one of examples 1 to 6 can optionally include that the connection determination circuit comprises a short circuit determination circuit configured to determine whether a short circuit is provided at the power supply connector; wherein the first input comprises an input different from a short circuit; and wherein the second input comprises a short circuit.

In example 8, the subject-matter of any one of examples 1 to 7 can optionally include that the exception processing comprises shutting down the computing device.

In example 9, the subject-matter of any one of examples 1 to 8 can optionally include that the exception processing comprises restarting the computing device.

In example 10, the subject-matter of any one of examples 1 to 9 can optionally include that the power supply connector comprises a plurality of contacts.

In example 11, the subject-matter of any one of examples 1 to 10 can optionally include that the power supply connector comprises a first contact and a second contact.

In example 12, the subject-matter of any one of examples 1 to 11 can optionally include that the exception circuit comprises a delay circuit configured to delay the exception processing by a pre-determined amount of time.

In example 13, the subject-matter of any one of examples 1 to 12 can optionally include a processor; wherein the exception processing comprises a reset of the processor.

Example 14 is a power supply device comprising: a power output connector; and a switch configured to switch between a first state in which the power output connector outputs an output for charging a computing device and a second state in which the power output connector outputs an output for initiating exception processing in the computing device.

In example 15, the subject-matter of example 14 can optionally include that the power output connector is configured to output a voltage of a first polarity in the first state and to output a voltage of a second polarity in the second state.

In example 16, the subject-matter of example 15 can optionally include that the power output connector comprises a first contact and a second contact.

In example 17, the subject-matter of example 16 can optionally include that the voltage of the first polarity comprises a plus pole at the first contact and a negative pole at the second contact.

In example 18, the subject-matter of any one of examples 16 to 17 can optionally include that the voltage of the second polarity comprises a negative pole at the first contact and a negative pole at the second contact.

In example 19, the subject-matter of any one of examples 14 to 18 can optionally include that the power output connector is configured to output a predetermined voltage in the first state and to output a short circuit in the second state.

Example 20 is a method for controlling a computing device, the method comprising: determining an input connected to a power supply connector of the computing device; charging a battery if a first input connected to the power supply connector is determined; and performing exception processing if a second input connected to the power supply connector is determined.

In example 21, the subject-matter of example 20 can optionally include that determining the input comprises determining a polarity of a power supply connected to the power supply connector; wherein the first input comprises a power supply of a first polarity; and wherein the second input comprises a power supply of a second polarity.

In example 22, the subject-matter of any one of examples 20 to 21 can optionally include that the first polarity is inverted compared to the second polarity.

In example 23, the subject-matter of any one of examples 21 to 22 can optionally include protecting the computing device from damage due to a voltage of the second polarity.

In example 24, the subject-matter of any one of examples 20 to 23 can optionally include that determining the input comprises determining whether a short circuit is provided at the power supply connector; wherein the first input comprises an input different from a short circuit; and wherein the second input comprises a short circuit.

In example 25, the subject-matter of any one of examples 20 to 24 can optionally include that the exception processing comprises shutting down the computing device.

In example 26, the subject-matter of any one of examples 20 to 25 can optionally include that the exception processing comprises restarting the computing device.

In example 27, the subject-matter of any one of examples 20 to 26 can optionally include that the power supply connector comprises a plurality of contacts.

In example 28, the subject-matter of any one of examples 20 to 27 can optionally include that the power supply connector comprises a first contact and a second contact.

In example 29, the subject-matter of any one of examples 20 to 28 can optionally include that the first polarity of the power supply comprises a plus pole of the power supply provided to the first contact and a negative pole of the power supply provided to the second contact.

In example 30, the subject-matter of any one of examples 20 to 29 can optionally include that the second polarity of the power supply comprises a negative pole of the power supply provided to the first contact and a plus pole of the power supply provided to the second contact.

In example 31, the subject-matter of any one of examples 20 to 30 can optionally include that the exception processing is carried out after a delay of a pre-determined amount of time.

In example 32, the subject-matter of any one of examples 20 to 31 can optionally include that the exception processing comprises a reset of a processor of the computing device.

Example 33 is a method for controlling a power supply device, the method comprising: switching, using a switch, between a first state in which a power output connector of the power supply device outputs an output for charging a computing device and a second state in which the power output connector outputs an output for initiating exception processing in the computing device.

In example 34, the subject-matter of example 33 can optionally include that the power output connector outputs a voltage of a first polarity in the first state and outputs a voltage of a second polarity in the second state.

In example 35, the subject-matter of any one of examples 33 to 34 can optionally include that the power output connector comprises a first contact and a second contact.

In example 36, the subject-matter of example 35 can optionally include that the voltage of the first polarity comprises a plus pole at the first contact and a negative pole at the second contact.

In example 37, the subject-matter of any one of examples 35 to 36 can optionally include that the voltage of the second polarity comprises a negative pole at the first contact and a negative pole at the second contact.

In example 38, the subject-matter of any one of examples 33 to 37 can optionally include that the power output connector outputs a predetermined voltage in the first state and outputs a short circuit in the second state.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A computing device comprising:
a battery;
a power supply connector;
a connection determination circuit configured to determine an input connected to the power supply connector;
a charging circuit configured to charge the battery if the connection determination circuit determines a first input connected to the power supply connector; and
an exception circuit configured to instruct the computing device to perform exception processing if the connection determination circuit determines a second input connected to the power supply connector.

2. The computing device of claim 1,
wherein the connection determination circuit comprises a voltage polarity determination circuit configured to determine a polarity of a power supply connected to the power supply connector;
wherein the first input comprises a power supply of a first polarity; and
wherein the second input comprises a power supply of a second polarity.

3. The computing device of claim 2,
wherein the first polarity is inverted compared to the second polarity.

4. The computing device of claim 2,
wherein the first polarity of the power supply comprises a plus pole of the power supply provided to the first contact and a negative pole of the power supply provided to the second contact.

5. The computing device of claim 2,
wherein the second polarity of the power supply comprises a negative pole of the power supply provided to the first contact and a plus pole of the power supply provided to the second contact.

6. The computing device of claim 2, further comprising:
a reverse voltage protection circuit configured to protect the computing device from damage due to a voltage of the second polarity.

7. The computing device of claim 1,
wherein the connection determination circuit comprises a short circuit determination circuit configured to determine whether a short circuit is provided at the power supply connector;
wherein the first input comprises an input different from a short circuit; and
wherein the second input comprises a short circuit.

8. The computing device of claim 1,
wherein the exception processing comprises shutting down the computing device.

9. The computing device of claim 1,
wherein the exception processing comprises restarting the computing device.

10. The computing device of claim 1,
wherein the power supply connector comprises a plurality of contacts.

11. The computing device of claim 1,
wherein the power supply connector comprises a first contact and a second contact.

12. The computing device of claim 1,
wherein the exception circuit comprises a delay circuit configured to delay the exception processing by a pre-determined amount of time.

13. The computing device of claim 1, further comprising:
a processor;
wherein the exception processing comprises a reset of the processor.

14. A power supply device comprising:
a power output connector; and
a switch configured to switch between a first state in which the power output connector outputs an output for charging a computing device and a second state in which the power output connector outputs an output for initiating exception processing in the computing device.

15. The power supply device of claim 14,
wherein the power output connector is configured to output a voltage of a first polarity in the first state and to output a voltage of a second polarity in the second state.

16. The power supply device of claim 15,
wherein the power output connector comprises a first contact and a second contact.

17. The power supply device of claim 16,
wherein the voltage of the first polarity comprises a plus pole at the first contact and a negative pole at the second contact.

18. The power supply device of claim 16,
wherein the voltage of the second polarity comprises a negative pole at the first contact and a negative pole at the second contact.

19. The power supply device of claim 14,
wherein the power output connector is configured to output a predetermined voltage in the first state and to output a short circuit in the second state.

20. A method for controlling a computing device, the method comprising:
determining an input connected to a power supply connector of the computing device;
charging a battery a first input connected to the power supply connector is determined; and
performing exception processing if a second input connected to the power supply connector is determined.

21. The method of claim 20,
wherein determining the input comprises determining a polarity of a power supply connected to the power supply connector;
wherein the first input comprises a power supply of a first polarity; and
wherein the second input comprises a power supply of a second polarity.

22. The method of claim 21,
wherein the first polarity is inverted compared to the second polarity.

23. The method of claim 21, further comprising:
protecting the computing device from damage due to a voltage of the second polarity.

24. The method of claim 20,
wherein determining the input comprises determining whether a short circuit is provided at the power supply connector;
wherein the first input comprises an input different from a short circuit; and
wherein the second input comprises a short circuit.

25. The method of claim 20,
wherein the exception processing comprises shutting down the computing device.

26. The method of claim 20,
wherein the exception processing comprises restarting the computing device.

27. The method of claim 20,
wherein the power supply connector comprises a plurality of contacts.

28. The method of claim 20,
wherein the power supply connector comprises a first contact and a second contact.

29. The method of claim 20,
wherein the first polarity of the power supply comprises a plus pole of the power supply provided to the first contact and a negative pole of the power supply provided to the second contact.

30. The method of claim 20,
wherein the second polarity of the power supply comprises a negative pole of the power supply provided to the first contact and a plus pole of the power supply provided to the second contact.

31. The method of claim 20,
wherein the exception processing is carried out after a delay of a pre-determined amount of time.

32. The method of claim 20,
wherein the exception processing comprises a reset of a processor of the computing device.

33. A method for controlling a power supply device, the method comprising:
switching, using a switch, between a first state in which a power output connector of the power supply device outputs an output for charging a computing device and a second state in which the power output connector outputs an output for initiating exception processing in the computing device.

34. The method of claim 33,
wherein the power output connector outputs a voltage of a first polarity in the first state and outputs a voltage of a second polarity in the second state.

35. The method of claim 33,
wherein the power output connector comprises a first contact and a second contact.

36. The method of claim 35,
wherein the voltage of the first polarity comprises a plus pole at the first contact and a negative pole at the second contact.

37. The method of claim 35,
wherein the voltage of the second polarity comprises a negative pole at the first contact and a negative pole at the second contact.

38. The method of claim 33,
wherein the power output connector outputs a predetermined voltage in the first state and outputs a short circuit in the second state.
